(19) United States
(12) Patent Application Publication
(10) Pub. No.: US 2002/0047061 A1
(43) Pub. Date: Apr. 25, 2002

(54) Coffee grinder silencer

(76) Inventors: Edward I. Wulfman, Woodinville, WA (US); Craig Lawson, Redmond, WA (US); Thomas P. Clark, La Mesa, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/900,473

(22) Filed: Jul. 6, 2001

Related U.S. Application Data
(60) Provisional application No. 60/216,474, filed on Jul. 6, 2000.

(51) Int. Cl. A47J 42/00

(52) U.S. Cl. 241/100

(57) ABSTRACT

The present silencer dampens the vibrations of various coffee grinders to soften the sound it produces when grinding beans. The present invention may comprise a base and a cap/cover formed from foam rubber which insulates the sound coming from the coffee grinder.

### RELATED APPLICATION

This application claims the benefit of prior provisional application No. 60/216,474, filed on Jul. 6, 2000, under 37 CFR §1.78(a)(3), the full disclosure of which is incorporated herein by reference.

### BACKGROUND OF THE INVENTION

Coffee grinders tend to be annoyingly loud. Thus, grinding coffee in the morning can be a very irritating experience, as it may tend to wake sleeping members of the household. What is desired is a quieter system for easily grinding coffee.

### SUMMARY OF THE INVENTION

In preferred aspects, the present invention provides a system for reducing noise from a coffee grinder, comprising: a base which receives a coffee grinder therein; and a cap which is received over the base and coffee grinder such that the coffee grinder is surrounded by the base and cap, wherein the base and cap together reduce the sound of the coffee grinder.

In preferred aspects, the present invention also provides a system for reducing noise from a coffee grinder, comprising: a base dimensioned to receive a coffee grinder therein; and a cap which is dimensioned to be received over the base and coffee grinder such that the coffee grinder is surrounded by the base and cap.

In a preferred aspect, either or both of the base or cap of the invention can be made of materials including (but not limited to) Neoprene™, open cell foam rubber, closed cell foam rubber, injected foam rubber, and acoustic foam rubber. Such materials are selected specifically to reduce noise and vibration. Thus, the present invention advantageously provides a quiet way to grind coffee beans. This is especially advantageous in the morning so the rest of the household members can sleep.

In preferred aspects, the present invention provides a foam rubber enclosure or “cuzzie” adaptable for use with various coffee grinders. The present invention may provide various important advantages, including noise control, aesthetics, and fall protection.

In preferred aspects, the present system is fitted around a coffee grinder to dampen the vibrations of the coffee grinder, thereby softening the sound it produces when grinding beans. The present invention may also insulate the sound coming from the coffee grinding unit. Such sounds come from various sources, including operation of the motor itself, the spinning blades hitting the beans, beans hitting the coffee grinder, and vibration of the unit on the surface that it is placed upon.

This present invention also provides pleasing aesthetics for the coffee grinder. For example, the present system can be made of any number of different colors to coordinate with the decor. Moreover, a stainless steel look can be used on the outside of a foam rubber body to give it a more commercial look and still provide the sound dampening. Moreover, the present system can be made in any shape, thus conforming to the exterior shape of various commercial coffee grinders.

When made of a material such as, for example, foam rubber, the present invention also advantageously provides fall protection of the coffee grinder. Specifically, if the grinder falls, the foam rubber will dampen the impact to minimize damage to the coffee grinder.

In one embodiment of the invention, the coffee grinder is received within a base and a small cap is positioned thereover. In another embodiment of the invention, the coffee grinder is positioned on a small base and the “cap” comprises An optional fall size cover which is positioned over the coffee grinder.

### BRIEF DESCRIPTION OF THE DRAWINGS

FIG. 1 is an exploded side elevation view of a first embodiment of the present invention.

FIG. 2 is an exploded side elevation view of a second embodiment of the present invention.

FIG. 3 is a top plan view of the present invention.

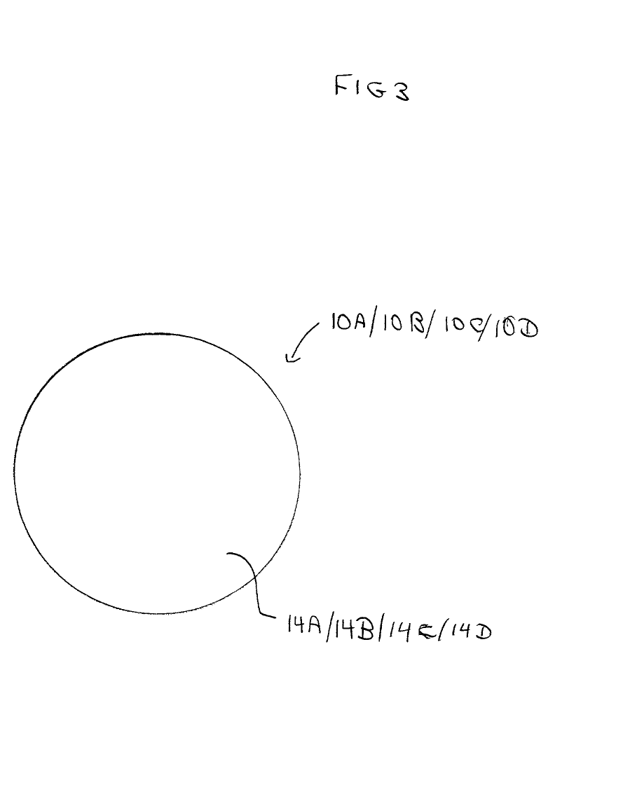

FIG. 4 is an exploded side elevation view of a third embodiment of the present invention.

FIG. 5 is an exploded side elevation view of a fourth embodiment of the present invention.

### DESCRIPTION OF THE SPECIFIC EMBODIMENTS

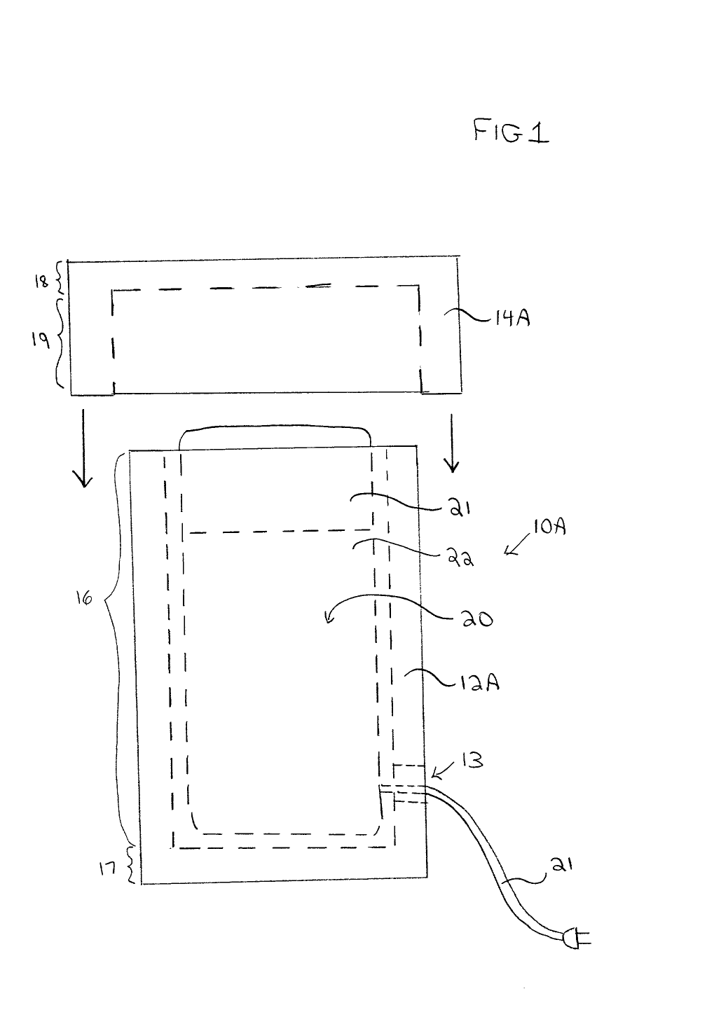

Referring first to FIG. 1, a first embodiment of the present system is provided. Silencer 10A comprises a base 12A and a cap 14A. Any standard coffee grinder 20 can be received therebetween, as shown. Typically, a standard coffee grinder will have a top portion 21 and a bottom portion 22. Top portion 21 is removed to insert coffee beans into the grinder and to remove ground coffee from the grinder.

When cap 14A is pushed downward, coffee grinder 20 is effectively surrounded by base 12A and cap 14A, which together reduce the sound of the coffee grinder.

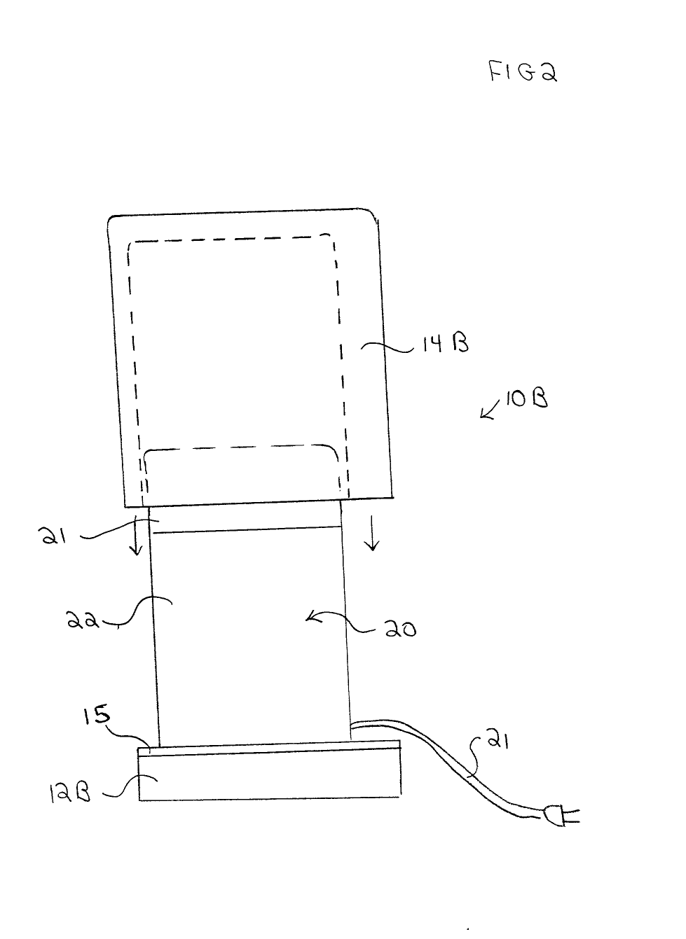

In preferred aspects, each of base 12A and cap 14A (or base 12B and cap 14B in FIG. 2) will be made of a material which inhibits acoustic noise and vibration. Exemplary materials include (but are not limited to) Neoprene™, various open cell foam rubbers, various closed cell foam rubbers, injected foam rubbers, or acoustic foam rubbers.

In optional preferred aspects, a hole 13 (which may comprise a small slit) in base 12A is provided to accommodate the passage of power cord 21 therethrough.

In a second embodiment of the invention, as shown in FIG. 2, a silencer 10B is provided. Silencer 10B provides a small base 12B and a larger “cap” (i.e. covering) 14B. Any standard coffee grinder 20 can be received therebetween, as shown. When cap/covering 14B is pushed downward, coffee grinder 20 is effectively surrounded by base 12B and cap 14B, which together reduce the sound of the coffee grinder.

In an optional preferred aspect of the second embodiment, an adhesive layer 15 is provided to directly attach base 12B to coffee grinder 20. Accordingly, base 12B may preferably comprise a disc of foam rubber that is glued to the base of a coffee grinder.

An additional advantage of base 12B is that it can even be used alone (i.e.: without cap 14B) to provide a more “cost effective” solution to the sound vibrations (e.g.: base 12B may be separately used as an inexpensive method to inhibit sound vibrations passing from the grinder to the table on which the grinder is positioned). In the absence of adhesive 15, base 12B could also be used as a coffee coaster to protect against heat from coffee cups onto a table surface (i.e.: base 12B may also be separately used as an inexpensive method to provide thermal insulation for coffee cups). Base 12B can also be used as a marketing tool for advertisement.

Bases 12A and 12B and cap/covers 14A and 14B may preferably be cylindrical, such that they can be received around a standard cylindrical shaped coffee grinder 20. However, other non-cylindrical shapes are also contemplated within the scope of the present invention.

In a preferred aspect, silencer 10A/10B can be made from Neoprene™, as follows. Base 12A can be made by sewing two parts (16 and 17) together. The first part 16 may be formed from a rectangular section of double-sided color fabric coated ¼ inch Neoprene™ which is cut to a preferred width and height such that it can be wrapped to form a cylinder of preferred dimensions. The resulting seam may then be glued and flat stitched to make the cylinder. Thereafter, a circular shaped section (part 17) may be cut out of the same material to form the bottom of the base 12A. This bottom portion may preferably be glued inside of the cylinder such that no stitching is required. The top of the cylinder may optionally be finished with cuff stretch material and sewed on. The back stitched seam may optionally comprise a ¾ inch (or similar dimensioned) opening 13 that allows the power cord to go through.

Cap 14A may be constructed similarly from two parts 18 and 19, with part 18 formed from a disk of foam material and part 19 formed from a rectangular piece of foam material wrapped together to have a cylindrical shape. Part 18 may comprise foam with ⅛th inch single sided Neoprene™, and part 19 may use foam with ¼ inch single sided Neoprene™. Parts 18 and 19 may preferably be single sided (with Neoprene™) to allow the bare foam rubber to stick to the top of the coffee grinder. The edge (between parts 18 and 19) may be glued and flat stitched and finished with cuff material.

In an alternate aspect, base 12 and cap/cover 14 may instead be molded. by standard injection molding techniques (e.g.: injecting foam rubber into a mold). The finished product may then be cleaned and stamped with a manufacturer's logo.

In preferred aspects, base 14B may be formed from Neoprene™ or extruded foam which is cut in to the dimension of the base of coffee grinder 20. Cuff material may then be sewn on and the logo silk screened on.

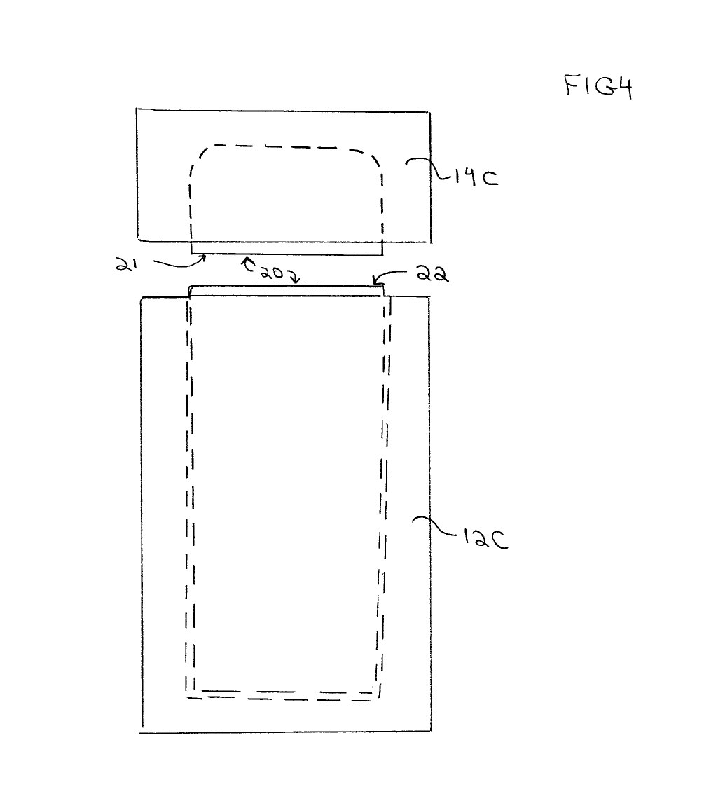

Referring to FIG. 4, a third embodiment of the present invention is seen in which base 12C and cap 14C are each received around the bottom 22 and top 21 portions of a standard coffee grinder 20. As such, as the top potion 21 of the coffee grinder is removed to place coffee beans therein, cap 14C remains disposed therearound. Similarly, base 12C remains disposed bottom portion 22 of coffee grinder 20. Optionally, base 12C may be glued to bottom portion 22 and cap 14C may be glued to top potion 21.

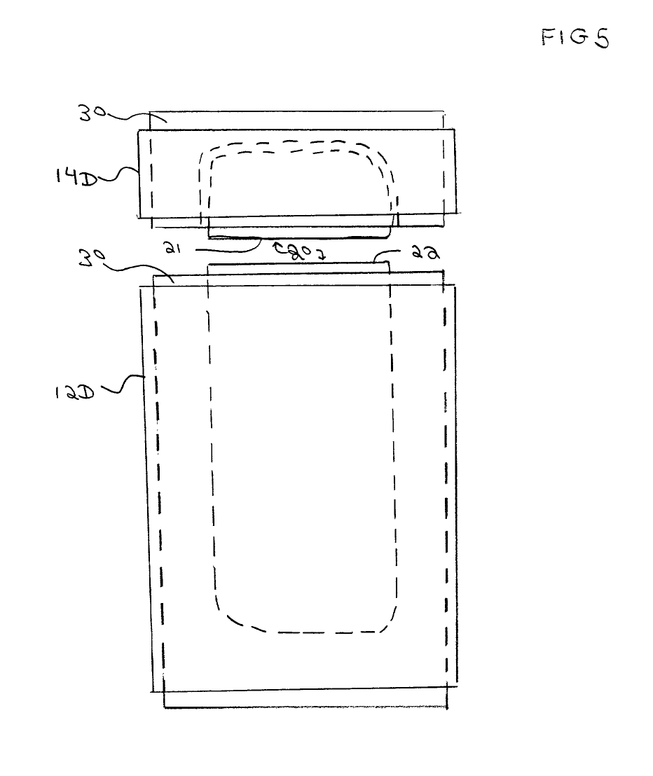

FIG. 5 shows a further embodiment of the invention in which acoustic insulation 30 (formed of the same materials and operating identical to above described base/caps 12A to 12C and 14A to 14C) is instead incorporated integrally within coffee grinder 20A. For example, insulation 30 may be covered by a decorative plate or metallic coverings, thus comprising base 12D and top 14D. Keeping within the scope of the present invention, other designs are possible in which the present acoustically insulating materials are incorporated within the interior of the body of the coffee grinder.

The Applicants have performed testing of the present invention. Silencer 10A has been found to provide approximately 10 decibels (dB) reduction in noise. In addition, the use of base 12B alone has been found to provide approximately 5 decibels (dB) reduction in noise.

What is claimed is:

1. A system for reducing noise from a coffee grinder, comprising:
a base which receives a coffee grinder therein; and
a cap which is received over the base and coffee grinder such that the coffee grinder is surrounded by the base and cap, wherein the base and cap together reduce the sound of the coffee grinder.

2. The system of claim 1, wherein the base and cap are made from material selected from the group consisting of Neoprene™, open cell foam rubber, closed cell foam rubber, injected foam rubber, and acoustic foam rubber.

3. A system for reducing noise from a coffee grinder, comprising:
a base dimensioned to receive a coffee grinder therein; and
a cap which is dimensioned to be received over the base and coffee grinder such that the coffee grinder is surrounded by the base and cap.

4. The system of claim 3, wherein the base is cylindrical.

5. The system of claim 3, wherein the base is made from material selected from the group consisting of Neoprene™, open cell foam rubber, closed cell foam rubber, injected foam rubber, and acoustic foam rubber.

6. The system of claim 3, wherein the cap is made from material selected from the group consisting of Neoprene™, open cell foam rubber, closed cell foam rubber, injected foam rubber, and acoustic foam rubber.

7. The system of claim 3, wherein the base has a hole passing therethrough which is dimensioned to permit passage of an electrical cord therethrough.

8. The system of claim 3, wherein the base is dimensioned to receive the coffee grinder therein.

9. A system for reducing noise from a coffee grinder, comprising:
a base dimensioned to position a coffee grinder thereon; and
a covering which is dimensioned to be received over the coffee grinder such that the coffee grinder is surrounded by the covering and base.

10. The system of claim 9, wherein the cap is dimensioned to receive the coffee grinder therein.

11. The system of claim 3, further comprising:
the coffee grinder.

12. The system of claim 9, further comprising:
the coffee grinder.

13. The system of claim 11, wherein the base is adhesively attached to the coffee grinder.

14. A reduced noise coffee grinder, comprising:
a coffee grinder having top and bottom portions, wherein each of the top and bottom portions comprise a layer of acoustically insulating material integral formed therein.

15. The system of claim 14, wherein the layers of acoustically insulating material is selected from the group consisting of Neoprene™, open cell foam rubber, closed cell foam rubber, injected foam rubber, and acoustic foam rubber.
